(19) United States
(12) Patent Application Publication
(10) Pub. No.: US 2017/0040699 A1
(43) Pub. Date: Feb. 9, 2017

(54) Antenna Device

(71) Applicant: Hitachi Metals, Ltd., Tokyo (JP)

(72) Inventors: Naoki ISO, Hitachi (JP); Masahisa KANETA, Hitachi (JP); Nobuaki KITANO, Hitachi (JP); Tomoyuki OGAWA, Hitachi (JP); Tsukasa FUJISHIMA, Tokai-mura (JP); Yoshiaki ISHIGAMI, Hitachi (JP)

(21) Appl. No.: 14/965,096

(22) Filed: Dec. 10, 2015

(30) Foreign Application Priority Data
Aug. 3, 2015 (JP) 2015-153163

(51) Int. Cl. H01Q 9/04; H01Q 1/38

(52) U.S. Cl. CPC H01Q 9/04; H01Q 1/38

(57) ABSTRACT

In an antenna device including an antenna element and a feeder line to supply power to the antenna element, the antenna device includes: a front surface feeder line and a rear surface feeder line on front and rear surfaces of a substrate; opposing upper-side and lower-side ground plates across the substrate; a coaxial cable including a center conductor connected to the front surface feeder line and the rear surface feeder line and an outer conductor connected to the upper-side ground plate; and a center conductor connection fitting including a substrate connection portion inserted between the upper-side ground plate and the lower-side ground plate and a first cable connection portion protruding to outside of the upper-side ground plate. First connection pieces of the substrate connection portion are connected to the front surface feeder line, and a second connection piece is connected to the rear surface feeder line.

### CROSS-REFERENCE TO RELATED APPLICATION

The present application claims priority from Japanese Patent Application No. 2015-153163 filed on Aug. 3, 2015, the content of which is hereby incorporated by reference into this application.

### TECHNICAL FIELD OF THE INVENTION

The present invention relates to an antenna device. More particularly, the present invention relates to an antenna device which is suitable for use as an antenna for a base station of a mobile phone.

### BACKGROUND OF THE INVENTION

An antenna device is provided with a substrate on which a feeder line is formed, an antenna element connected to the feeder line on the substrate, and a casing (radome) that houses these substrate and antenna element.

In a general antenna device, a coaxial cable drawn into the casing is connected to the feeder line on the substrate inside the casing. More specifically, a center conductor of the coaxial cable drawn into the casing is electrically connected to the feeder line via a connection member or others.

### PRIOR ART DOCUMENT

### Patent Document

Patent Document 1: Japanese Patent Application Laid-Open Publication No. 2015-50532

### SUMMARY OF THE INVENTION

When the coaxial cable and the feeder line are connected to each other, it is required to not only secure a mechanical strength of a connection portion but also connect the coaxial cable with the feeder line without degrading electrical characteristics.

An object of the present invention is to achieve an antenna device having a coaxial cable and a feeder line connected to each other without degrading electrical characteristic as much as possible.

An antenna device of the present invention is an antenna device provided with an antenna element and a feeder line to supply power to the antenna element. The antenna device includes: a substrate; a front surface feeder line formed on a front surface of the substrate; a rear surface feeder line formed on a rear surface of the substrate; a first ground plate and a second ground plate which oppose each other across the substrate; a coaxial cable provided with a center conductor connected to the front surface feeder line and the rear surface feeder line and with an outer conductor connected to the first ground plate; and a center conductor connection fitting provided with a substrate connection portion which is inserted between the first ground plate and the second ground plate and with a first cable connection portion which protrudes to outside of the first ground plate. Further, a first connection piece of the substrate connection portion is connected to the front surface feeder line, and a second connection piece of the substrate connection portion is connected to the rear surface feeder line.

In an aspect of the present invention, the second connection piece is connected to the rear surface feeder line so as to penetrate through the substrate.

In another aspect of the present invention, a slit, which penetrates through the substrate and which communicates with the front surface feeder line and the rear surface feeder line, is formed in the substrate, the second connection piece passes through the slit and penetrates through the substrate, and a portion between an inner surface of the slit and an outer surface of the second connection piece has a gap which allows solder to go around from the front surface to the rear surface of the substrate.

In another aspect of the present invention, one second connection piece described above is provided, two first connection pieces described above are provided, and the two first connection pieces are arranged on both sides of one second connection piece described above.

In still another aspect of the present invention, a bent portion, which extends in parallel with the substrate and which is arranged so as to overlap on the front surface feeder line, is provided in the first connection piece.

In still another aspect of the present invention, a width of the substrate connection portion is narrower than a width of the first cable connection portion.

In still another aspect of the present invention, an outer conductor connection fitting is provided so as to be arranged on the first ground plate across over the coaxial cable and so as to sandwich the coaxial cable between itself and the first ground plate. The outer conductor connection fitting is provided with a second cable connection portion connected to the outer conductor of the coaxial cable and with a fixing portion fixed to the first ground plate.

In still another aspect of the present invention, a solder injection hole which penetrates through the second cable connection portion is provided in the second cable connection portion.

According to the present invention, an antenna device having a coaxial cable and a feeder line connected to each other without degrading electrical characteristics as much as possible is achieved.

### BRIEF DESCRIPTIONS OF THE DRAWINGS

FIG. 1 is a perspective view illustrating an example of an antenna device to which the present invention is applied;

FIG. 2 is a partially enlarged perspective view illustrating an internal structure of the antenna device to which the present invention is applied;

FIG. 3 is an enlarged plan view schematically illustrating an end portion of a feeder line to which a coaxial cable is connected;

FIG. 4A is a side view of a center conductor connection fitting, and FIG. 4B is a front view of the center conductor connection fitting;

FIG. 5A is a front view of the outer conductor connection fitting, and FIG. 5B is a plan view of the outer conductor connection fitting;

FIG. 6 is a plan view illustrating a coaxial cable connection structure using the center conductor connection fitting and the outer conductor connection fitting;

FIG. 7 is a front view of a partial cross-section illustrating the coaxial, cable connection structure using the center conductor connection fitting and the outer conductor connection fitting; and

FIG. 8 is a cross-sectional view taken along a line X-X of FIG. 7.

### DESCRIPTIONS OF THE PREFERRED EMBODIMENTS

Hereinafter, an embodiment example of the present invention will be described with reference to the drawings.

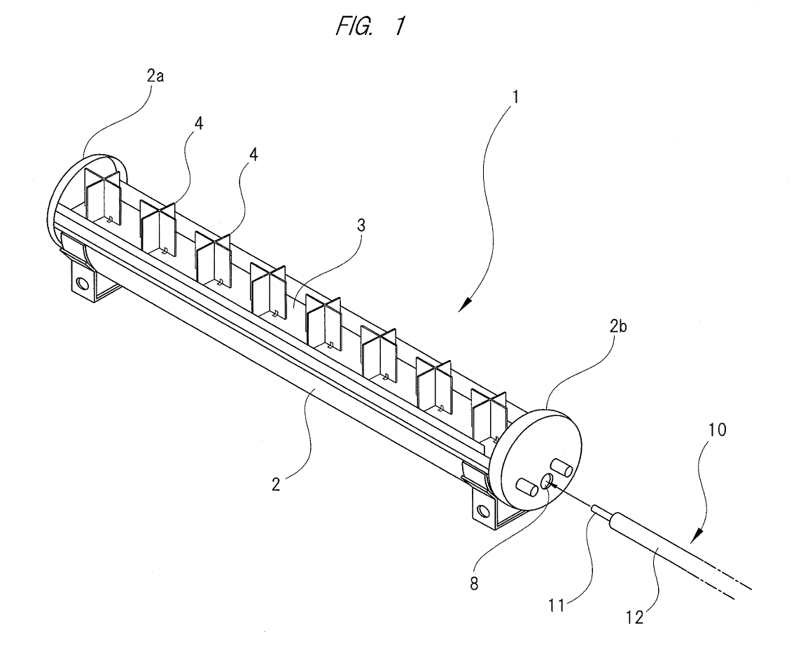

An antenna device 1 illustrated in FIG. 1 has a casing 2 having a substantially cylindrical shape, which is generally referred to as a “radome”. Caps 2a and 2b are provided on both ends in a longitudinal direction of the casing 2, and a first ground plate 3 having a substantially rectangular shape which extends along the longitudinal direction of the casing 2 is housed inside the casing 2. In addition, a plurality of antenna elements 4 are placed on the first ground plate 3 while being linearly arranged along the longitudinal direction of the first ground plate 3.

Generally, the antenna device 1 is set at a high place such as a rooftop of a building so as to vertically or substantially vertically stand while the cap 2b is on a lower side. In FIG. 1, note that illustration of a part of the casing 2 is omitted so that an inside thereof is exposed in order to illustrate the inside of the casing 2. In addition, eight antenna elements 4 are provided in the antenna device 1 according to the present embodiment. However, the number of the antenna elements 4 is not limited to a specific number.

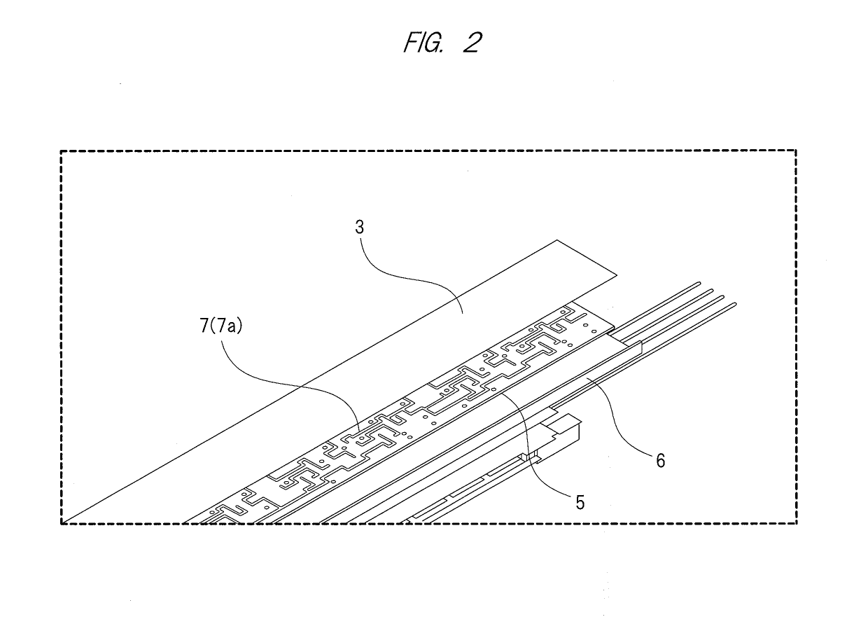

In addition to the first ground plate 3 and the antenna element 4 illustrated in FIG. 1, a substrate and a second ground plate are housed inside the casing 2. More specifically, as illustrated in FIG. 2, a substrate 5 having a substantially rectangular shape is arranged in parallel with the first ground plate 3 below the first ground plate 3, and a second ground plate 6 having a substantially rectangular shape is arranged in parallel with the substrate 5 below the substrate 5. In the following description, the first ground plate 3 will be referred to as the “upper-side ground plate 3”, and the second ground plate 6 will be referred to as the “lower-side ground plate 6” in some cases. That is, the upper-side ground plate 3 and the lower-side ground plate 6 oppose each other across the substrate 5. In other words, the substrate 5 is arranged between the upper-side ground plate 3 and the lower-side ground plate 6 opposing each other.

The lower-side ground plate 6 is formed so as to have a C-shaped cross-section having side wall portions formed by bending both ends in a width direction toward the upper-side ground plate 3 at a right angle. The substrate 5 is arranged between the side wall portions opposing each other in the lower-side ground plate 6, and the upper-side ground plate 3 is placed on an end surface of the side wall portion of the lower-side ground plate 6.

A feeder line 7 to supply power to the antenna element 4 (FIG. 1) is formed on front and rear surfaces of the substrate 5. FIG. 2 illustrates only the feeder line 7 formed on the front surface (surface opposing the upper-side ground plate 3) of the substrate 5. However, the feeder line 7 is formed also on the rear surface (surface opposing the lower-side ground plate 6) of the substrate 5. In the present embodiment, the feeder lines 7 formed on the front and rear surfaces of the substrate 5 are electrically conducted, and the same signal flows in these feeder lines 7. In the following description, the feeder line 7 formed on the front surface of the substrate 5 will be referred to as a “front surface feeder line 7a”, and the feeder line 7 formed on the rear surface of the substrate 5 will be referred to as a “rear surface feeder line 7b” in some cases. In addition, the front surface feeder line 7a and the rear surface feeder line 7b are sometimes collectively referred to as the “feeder line 7” if it is not particularly required to distinguish them from each other. That is, a tri-plate line is formed as a whole by using the upper-side ground plate 3 and the lower-side ground plate 6 and the substrate 5 which is arranged between these ground plates 3 and 6 and which has the front and rear surfaces on which the feeder lines 7 are formed.

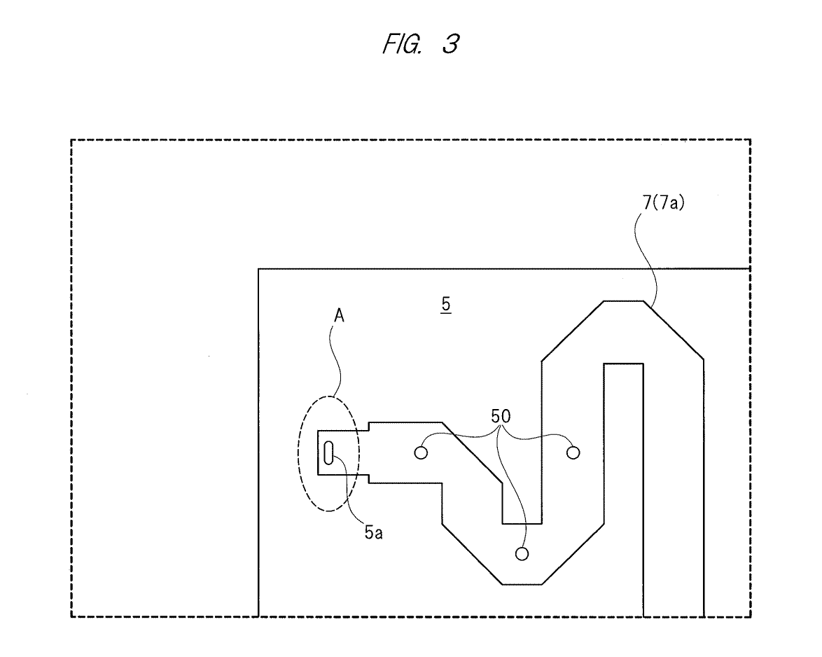

With reference to FIG. 1 again, a cable insertion opening 8 communicating inside and outside the casing 2 is provided in the one cap 2b of the casing 2, and a coaxial cable 10 is drawn from the cable insertion opening 8 into the casing 2. The coaxial cable 10 drawn into the casing 2 is connected to each of the feeder line 7 and the upper-side ground plate 3. Specifically, a center conductor 11 (FIG. 1) of the coaxial cable 10 is connected to the feeder line 7 via a first connection member, and an outer conductor (not illustrated in FIG. 1) of the coaxial cable 10 is connected to the upper-side ground plate 3 via a second connection member. More specifically, the center conductor 11 of the coaxial cable 10 is connected to an end portion A of the feeder line 7 as illustrated in FIG. 3. The end portion A of the feeder line 7 illustrated in FIG. 3 is positioned on one end side in the longitudinal direction of the substrate 5 (FIG. 2) close to the cap 2b illustrated in FIG. 1. However, a position of the feeder line end portion A, to which the center conductor 11 is connected, on the substrate 5 is not limited to the above-described position. On the other hand, if the position of the feeder line end portion A, to which the center conductor 11 is connected, on the substrate 5 is the above-described position, there is an advantage that the center conductor 11 and the feeder line end portion A can be connected to each other with a short distance.

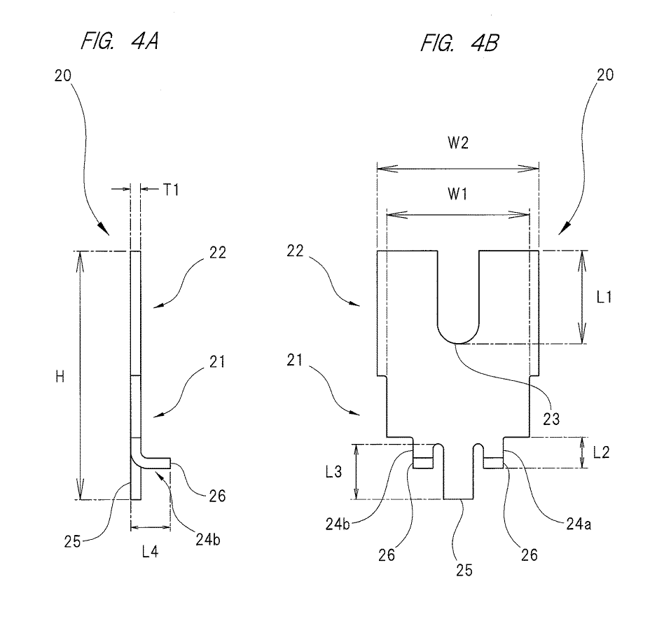

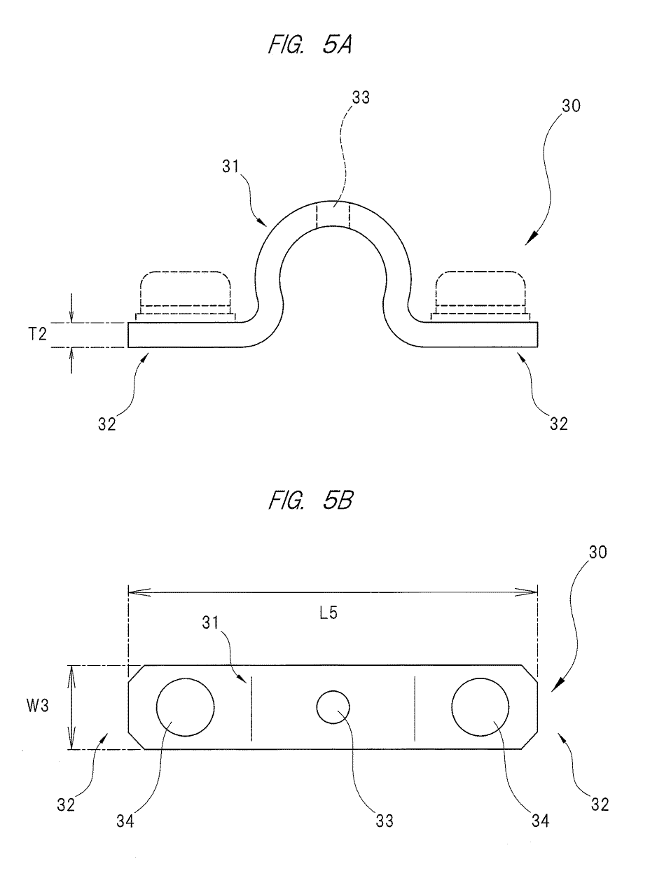

Next, a connection structure among the coaxial cable 10, the feeder line 7, and the upper-side ground plate 3 will be described in detail. In the present embodiment, a center conductor connection fitting 20 illustrated in FIGS. 4A and 4B is used as the first connection member that connects the center conductor 11 of the coaxial cable 10 with the feeder line 7. In addition, an outer conductor connection fitting 30 illustrated in FIGS. 5A and 5B is used as the second connection member that connects the outer conductor of the coaxial cable 10 with the upper-side ground plate 3.

The center conductor connection fitting 20 illustrated in FIGS. 4A and 4B is provided with a substrate connection portion 21 and a first cable connection portion 22. Incidentally, the center conductor connection fitting 20 is obtained by processing a copper plate whose surface is subjected to tin plating into the illustrated shape, and the substrate connection portion 21 and the first cable connection portion 22 are integrated to each other.

A width (W1) of the substrate connection portion 21 of the center conductor connection fitting 20 illustrated in FIG. 4B is 7.0 mm, and a width (W2) of the first cable connection portion 22 is 8.0 mm. That is, the width (W1) of the substrate connection portion 21 is narrower than the width (W2) of the first cable connection portion 22. In addition, a height (H) of the center conductor connection fitting 20 illustrated in FIG. 4A is 12.0 mm, and a thickness (T1) thereof is 0.5 mm.

As illustrated in FIG. 4B, a notch 23 which extends in a height direction of the center conductor connection fitting 20 is formed in the first cable connection portion 22. A length (L1) of the notch 23 is 5.5 mm, and a lower end of the notch 23 is formed in an arc shape.

As illustrated in FIGS. 4A and 4B, a plurality of connection pieces are provided in the substrate connection portion 21. Specifically, two first connection pieces 24a and 24b, and one second connection piece 25 are provided in the substrate connection portion 21, and the two first connection pieces 24a and 24b are arranged on both sides of the second connection piece 25. In other words, the one second connection piece 25 is arranged between the two first connection pieces 24a and 24b. Further, a bent portion 26 bent substantially at 90 degrees is provided in each tip end of the first connection pieces 24a and 24b.

Here, each length (L2) of the first connection pieces 24a and 24b illustrated in FIG. 4B is 1.5 mm, and a length (L3) of the second connection piece 25 is 3.0 mm. In addition, a length (L4) of the bent portion 26 illustrated in FIG. 4A is 2.0 mm.

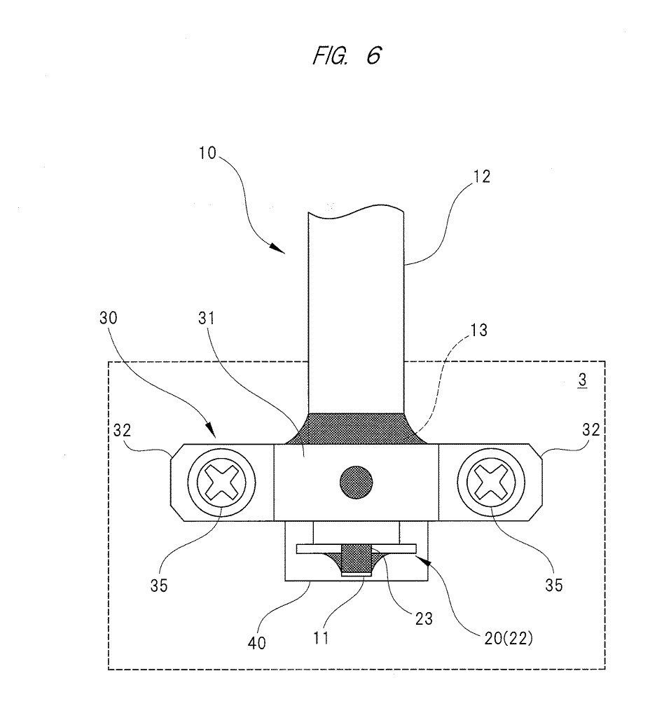

As illustrated in FIGS. 6 to 8, the center conductor connection fitting 20 is arranged at an inner side of an opening portion 40 having a substantially rectangular shape provided in the upper-side ground plate 3, the substrate connection portion 21 is inserted into a part between the upper-side ground plate 3 and the lower-side ground plate 6, and the first cable connection portion 22 protrudes to the outside (upper side) of the upper-side ground plate 3.

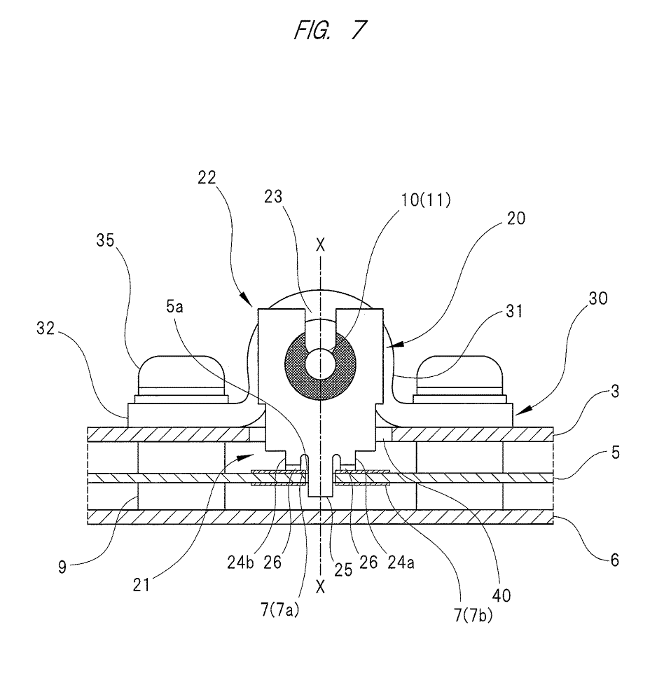

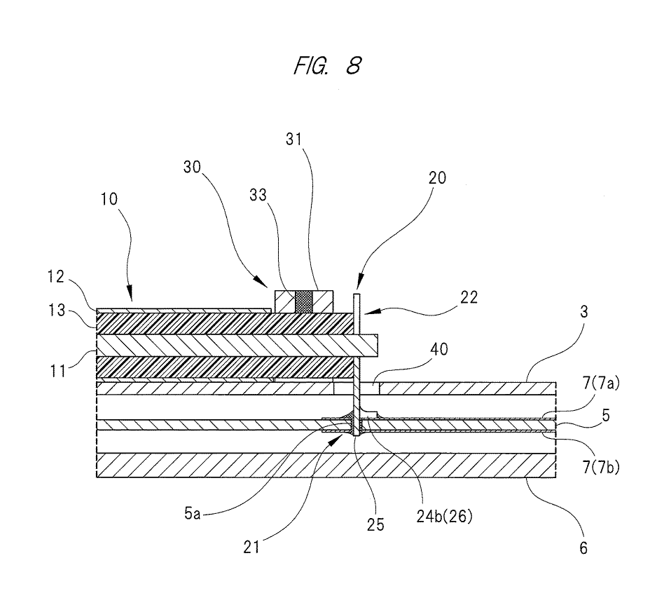

As illustrated in FIGS. 7 and 8, the first connection pieces 24a and 24b of the substrate connection portion 21, inserted into the part between the upper-side ground plate 3 and the lower-side ground plate 6, are connected to the front surface feeder line 7a. Specifically, the bent portion 26 of the first connection pieces 24a and 24b which is bent substantially at 90 degrees extends in parallel with the substrate 5, that is, in parallel with the front surface feeder line 7a. The bent portion 26 of the first connection pieces 24a and 24b is arranged so as to overlap on the front surface feeder line 7a, and is soldered to the front surface feeder line 7a.

In addition, as illustrated in FIGS. 7 and 8, the second connection piece 25 of the substrate connection portion 21, inserted into a part between the upper-side ground plate 3 and the lower-side ground plate 6, is connected to the rear surface feeder line 7b. Specifically, in the substrate 5, a slit 5a, which penetrates through the substrate 5 and which communicates with the front surface feeder line 7a and the rear surface feeder line 7b, is formed (see FIG. 3). The second connection piece 25 is inserted into the slit 5a and penetrates through the substrate 5. Further, a part of the second connection piece 25 protruding from the rear surface of the substrate is soldered to the rear surface feeder line 7b.

Here, an inner dimension of the slit 5a is set to be slightly larger than an outer dimension of the second connection piece 25. Accordingly, when the second connection piece 25 is inserted into the slit 5a, a gap which is as large as the solder goes around from the front surface to the rear surface of the substrate 5 is generated between an inner surface of the slit 5a and an outer surface of the second connection piece 25. Therefore, when the second connection piece 25 is inserted into the slit 5a, and then, the melted solder is supplied to the periphery of the slit 5a from the front surface side of the substrate 5 while arranging the bent portion 26 of the first connection pieces 24a and 24b so as to overlap on the front surface feeder line 7a, the supplied solder passes through the slit 5a and goes around the rear surface side of the substrate 5. In this manner, the first connection pieces 24a and 24b are soldered to the front surface feeder line 7a, and simultaneously, the second connection piece 25 is soldered to the rear surface feeder line 7b. Further, since the sufficient amount of the solder is supplied to the rear surface side of the substrate 5, the second connection piece 25 and the rear surface feeder line 7b are more strongly bonded to each other, and the electrical conduction between them is more reliably secured.

As illustrated in FIGS. 6 and 7, the first cable connection portion 22 protruding from the upper-side ground plate 3 is connected to the center conductor 11 of the coaxial cable 10. Specifically, a sheathe 12, an outer conductor 13 and an insulator are removed, and the center conductor 11 exposed to the outside is put into the notch 23 of the first cable connection portion 22. Further, the center conductor 11 put into the notch 23 is bonded to the first cable connection portion 22 by the solder spreading over the center conductor 11 and the periphery of the notch 23.

As described above, the first cable connection portion 22 of the center conductor connection fitting 20 is connected to the center conductor 11 of the coaxial cable 10. In addition, the first connection pieces 24a and 24b of the center conductor connection fitting 20 are connected to the front surface feeder line 7a, and the second connection piece 25 of the center conductor connection fitting 20 is connected to the rear surface feeder line 7b. That is, the center conductor 11 of the coaxial cable 10 is electrically conducted to both the front surface feeder line 7a and the rear surface feeder line 7b via the center conductor connection fitting 20.

The outer conductor connection fitting 30 illustrated in FIGS. 5A and 5B is provided with a second cable connection portion 31, and two fixing portions 32 which extend on both sides of the second cable connection portion 31. Incidentally, the center conductor connection fitting 30 is obtained by processing a copper plate whose surface is subjected to tin plating into the illustrated shape, and the second cable connection portion 31 and the fixing portions 32 are integrated to each other.

A thickness (T2) of the outer conductor connection fitting 30 illustrated in FIG. 5A is 1.5 mm. In addition, a width (W3) of the outer conductor connection fitting 30 illustrated in FIG. 5B is 5.0 mm, and a length (L5) thereof is 25.0 mm.

As illustrated in FIG. 5A, the second cable connection portion 31 is formed in a semicircular arc shape following an outer shape of the coaxial cable 10 (FIG. 1), and the fixing portions 32 linearly extends, respectively, from both ends of the second cable connection portion 31 to the outer side. A solder injection hole 33 penetrating through the second cable connection portion 31 is formed at a vertex of the second cable connection portion 31, and a bolt hole 34 through which a bolt is inserted is formed in each of the fixing portions 32.

As illustrated in FIGS. 6 to 8, the outer conductor connection fitting 30 is arranged on the upper-side ground plate 3 so as to be over across the coaxial cable 10, and is fixed to the upper-side ground plate 3. As illustrated in FIGS. 6 and 7, the second cable connection portion 31 of the outer conductor connection fitting 30 arranged on the upper-side ground plate 3 covers the exposed outer conductor 13 of the coaxial cable 10 so as to be over across the outer conductor 13. In addition, the fixing portions 32 extending from both ends of the second cable connection portion 31 to the outside of the coaxial cable 10 in the radial direction are placed on the front surface of the upper-side ground plate 3, and are fixed to the upper-side ground plate 3 by a fixing bolt 35 inserted through the bolt hole 34 (FIGS. 5A and 5B). That is, the coaxial cable 10 is sandwiched between the outer conductor connection fitting 30 and the upper-side ground plate 3.

The outer conductor connection fitting 30 sandwiching the coaxial cable 10 is connected to the outer conductor 13 of the coaxial cable 10. Specifically, the outer conductor connection fitting 30 is bonded to the outer conductor 13 by the solder spreading across over a part between the outer conductor 13 and a side surface of the second cable connection portion 31. Further, as illustrated in FIG. 8, the outer conductor connection fitting 30 is bonded to the outer conductor 13 also by the solder injected into the solder injection hole 33 of the second cable connection portion 31. Although not illustrated in FIG. 8, the solder injected into the solder injection hole 33 flows between an inner circumferential surface of the second cable connection portion 31 and an outer circumferential surface of the outer conductor 13, and bonds both the surfaces. Therefore, the outer conductor connection fitting 30 and the outer conductor 13 are more strongly bonded to each other, and the electrical conduction between them is more reliably secured. Although omitted in the attached drawings of the present specification including FIG. 8, note that polyethylene foam or other insulator is interposed between the center conductor 11 and the outer conductor 13 illustrated in FIG. 8.

As described above, the second cable connection portion 31 of the outer conductor connection fitting 30 is connected to the outer conductor 13 of the coaxial cable 10. In addition, the fixing portion 32 of the outer conductor connection fitting 30 is connected to the upper-side ground plate 3. That is, the outer conductor 13 of the coaxial cable 10 is electrically conducted with the upper-side ground plate 3 via the outer conductor connection fitting 30.

As illustrated in FIG. 7, note that an aluminum spacer 9 is interposed between the upper-side ground plate 3 and the lower-side ground plate 6, and the fixing bolt 35 is screwed with the spacer 9.

As described above, in the present embodiment, the center conductor 11 of the coaxial cable 10 and the feeder line 7 are connected to each other via the center conductor connection fitting 20 without degrading the electrical characteristics. In addition, the outer conductor 13 of the coaxial cable 10 and the upper-side ground plate 3 are connected to each other via the outer conductor connection fitting 30 without degrading the electrical characteristics.

Note that formation of three or more through-holes in a range of a predetermined distance from a connection point between the coaxial cable 10 and the feeder line 7 further stabilizes the electrical characteristics. For example, as illustrated in FIG. 3, formation of three or more through-holes 50 in a range of a line length of 40 mm from the slit 5a which is the connection point between the coaxial cable 10 and the feeder line 7 further stabilizes the electrical characteristics.

The present invention is not limited to the embodiments described above, and various modifications thereof can be made within the scope of the concept. For example, various dimensions in relation to the center conductor connection fitting or the outer conductor connection fitting described in the embodiments are examples, and can be modified appropriately. In addition, materials of the center conductor connection fitting and the outer conductor connection fitting may be such materials as being capable of solder bonding, and are not limited to copper or a copper alloy.

What is claimed is:

1. An antenna device provided with an antenna element, and a feeder line to supply power to the antenna element, comprising:
a substrate;
a front surface feeder line formed on a front surface of the substrate;
a rear surface feeder line formed on a rear surface of the substrate;
a first ground plate and a second ground plate which oppose each other across the substrate;
a coaxial cable provided with a center conductor connected to the front surface feeder line and the rear surface feeder line, and with an outer conductor connected to the first ground plate; and
a center conductor connection fitting provided with a substrate connection portion which is inserted between the first ground plate and the second ground plate, and with a first cable connection portion which protrudes to outside of the first ground plate,
wherein a first connection piece of the substrate connection portion is connected to the front surface feeder line, and a second connection piece of the substrate connection portion is connected to the rear surface feeder line.

2. The antenna device according to claim 1,
wherein the second connection piece penetrates through the substrate and is connected to the rear surface feeder line.

3. The antenna device according to claim 2,
wherein a slit which penetrates through the substrate and which communicates with the front surface feeder line and the rear surface feeder line is formed in the substrate,
the second connection piece passes through the slit, and penetrates through the substrate, and
a portion between an inner surface of the slit and an outer surface of the second connection piece has a gap through which solder goes around the rear surface of the substrate from the front surface thereof.

4. The antenna device according to claim 2 further comprising
the second connection piece provided as one piece and the first connection pieces provided as two pieces,
wherein the two first connection pieces are provided on both sides of the one second connection piece.

5. The antenna device according to claim 1,
wherein a bent portion which extends in parallel with the substrate and which is arranged so as to overlap on the front surface feeder line is provided in the first connection piece.

6. The antenna device according to claim 1,
wherein a width of the substrate connection portion is narrower than a width of the first cable connection portion.

7. The antenna device according to claim 1, further comprising
an outer conductor connection fitting which is arranged on the first ground plate over across the coaxial cable and which sandwiches the coaxial cable between the outer conductor connection fitting itself and the first ground plate,
wherein the outer conductor connection fitting is provided with a second cable connection portion connected to the outer conductor of the coaxial cable, and with a fixing portion fixed to the first ground plate.

8. The antenna device according to claim 7,
wherein a solder injection hole which penetrates through the second cable connection portion is provided in the second cable connection portion.
